(19) United States
(12) Patent Application Publication
(10) Pub. No.: US 2011/0057069 A1
(43) Pub. Date: Mar. 10, 2011

(54) Coated Paperboard Core For Elastomeric Fiber Production

(75) Inventors: Ismael A. Hernandez, Florence, SC (US); Charles Lounsbury, Florence, SC (US)

(73) Assignee: Sonoco Development, Inc., Hartsville, SC (US)

(21) Appl. No.: 12/555,984

(22) Filed: Sep. 9, 2009

(51) Int. Cl. B65H 75/18; B65H 75/10; B31C 11/04; B31C 7/00

(52) U.S. Cl. 242/610.1; 493/273; 493/274; 493/296

(57) ABSTRACT

A paperboard core suitable for use in winding yarns may include strips of paperboard wrapped about an axis and secured together to form an elongate structure defining a winding surface. A coating of a polymer such as polyvinylidene chloride covers the winding surface. The coating may be applied to the strips of paperboard prior to winding and/or applied to the winding surface after winding. The coating may comprise multiple layers of the polymer, which may be cured individually. The coating may also be applied so as to create a substantially uninterrupted coating along the winding surface. One method of applying the coating is by roll-coating.

### BACKGROUND OF THE INVENTION

1. Field of the Invention

The invention relates to coated paperboard cores suitable for use in winding yarns.

2. Description of Related Art

The production of elastomeric yarn such as spandex often involves winding of the yarn onto a core. However, adequate friction between the moving yarn and the surface of the core is required in order to start winding the yarn on the core. Additionally, as the cores are typically formed from paperboard, the surface of the paperboard core must be designed to resist the penetration of yarn oils such as lubricants and antistats in order to maintain the structural integrity of the paperboard core. Further, migration of the yarn oils from the yarn to the paperboard core may compromise the efficacy of the lubricants and antistats.

In the past, attempts to solve these problems have entailed adhering a film to the outside of the core. Such films have been composed of polyester, cellophane, polyethylene, and polyvinylidene chloride (PVDC), such as SARAN™.

### SUMMARY OF VARIOUS EMBODIMENTS

The present disclosure in one aspect describes a paperboard core suitable for use in winding yarns. The paperboard core comprises one or more strips of paperboard wrapped about an axis and secured together to form an elongate structure, the elongate structure defining a winding surface. A coating, which may comprise a PVDC polymer, covers the winding surface, wherein the coating is applied to the winding surface as a liquid and then cured.

In some embodiments, the coating may be applied by roll-coating, and may be substantially uninterrupted along the winding surface. The coating may comprise a plurality of individually applied layers, with each of the plurality of layers being cured before the next layer is applied atop it. Additionally, the paperboard core may be repulpable without first removing the PVDC polymer. Further, the elongate structure may comprise a tubular or conical shape.

Embodiments of the invention further include a method of manufacturing a paperboard core suitable for use in winding yarns. The method comprises the step of winding one or more strips of paperboard about an axis to form an elongate structure defining a winding surface. The method further comprises the steps of applying a coating of a polyvinylidene chloride polymer to the paperboard and curing the coating.

In some embodiments the step of applying the coating may comprise coating the winding surface, such as by roll-coating the polymer onto the winding surface. Additionally, the method may include creating a substantially uninterrupted coating along the winding surface. The step of applying the coating may comprise applying a single layer or a plurality of layers of the polymer. When multiple layers are applied, the step of curing the coating may be repeated for each of the plurality of layers of the polymer.

In further embodiments, the coating may be applied to a radially outer surface of at least one of the one or more strips prior to the step of winding the one or more strips to form the elongate structure. In such embodiments the coating may be roll-coated onto the radially outer surface. Further, one or more additional coats of the polymer may be applied to the winding surface after the step of winding the one or more strips which have been previously coated.

### BRIEF DESCRIPTION OF THE SEVERAL VIEWS OF THE DRAWING(S)

Having thus described the embodiments in general terms, reference will now be made to the accompanying drawings, which are not necessarily drawn to scale, and wherein:

FIG. 1 illustrates an embodiment of a partially disassembled paperboard core;

FIG. 2 illustrates embodiments of a method of manufacturing a paperboard core;

FIG. 3 illustrates results from moisture vapor transmission rates testing of paperboard samples;

FIG. 4 illustrates results from porosity testing of paperboard samples;

FIG. 5 illustrates basis weights for paperboard samples;

FIG. 6 illustrates a frictional force testing apparatus in a first position;

FIG. 7 illustrates a frictional force testing apparatus in a second position;

FIG. 8 illustrates frictional force testing results for a cellophane film-covered paperboard sample;

FIG. 9 illustrates additional frictional force testing results for the cellophane film-covered paperboard sample tested in FIG. 8;

FIG. 10 illustrates frictional force testing results for a SARAN™ film-covered paperboard sample;

FIG. 11 illustrates additional frictional force testing results for the SARAN™ film-covered paperboard sample tested in FIG. 10;

FIG. 12 illustrates frictional force test results for a coated paperboard sample comprising one layer of polymer;

FIG. 13 illustrates frictional force test results for a coated paperboard sample comprising two layers of polymer;

FIG. 14 illustrates frictional force test results for a coated paperboard sample comprising three layers of polymer; and

FIG. 15 illustrates frictional force test results for a coated paperboard sample comprising four layers of polymer.

### DETAILED DESCRIPTION OF THE DRAWINGS

Coated paperboard cores will now be described more fully hereinafter with reference to the accompanying drawings in which some but not all embodiments are shown. Indeed, the present development may be embodied in many different forms and should not be construed as limited to the embodiments set forth herein; rather, these embodiments are provided so that this disclosure will satisfy applicable legal requirements. Like numbers refer to like elements throughout.

As described above, film has been used in the past to prevent yarn oil from migrating into paperboard cores. A film refers to a thin sheet of solid material that is wrapped around the paperboard core. As will be described below, the use of a film may result in unsatisfactory results, and hence Applicants have made use of a coating for a paperboard core. A coating refers to a substance that is applied in a liquid form, as opposed to a solid.

Applicants have discovered that use of a pre-manufactured film for covering a paperboard core for use in winding elastomeric yarns is undesirable for a number of reasons. For example, the film is typically wound in a helical fashion onto the paperboard core, and hence there may be gaps between each wrap of the film around the paperboard core. Alternatively, the film may be overlapped on each wrap, but this creates undesirable bumps along the surface of the paperboard core at the overlapping joints. Also, in order to recycle film-covered paperboard cores, either the film must be removed prior to recycling, or else costly sorting and filtering equipment must be incorporated into the recycling machinery.

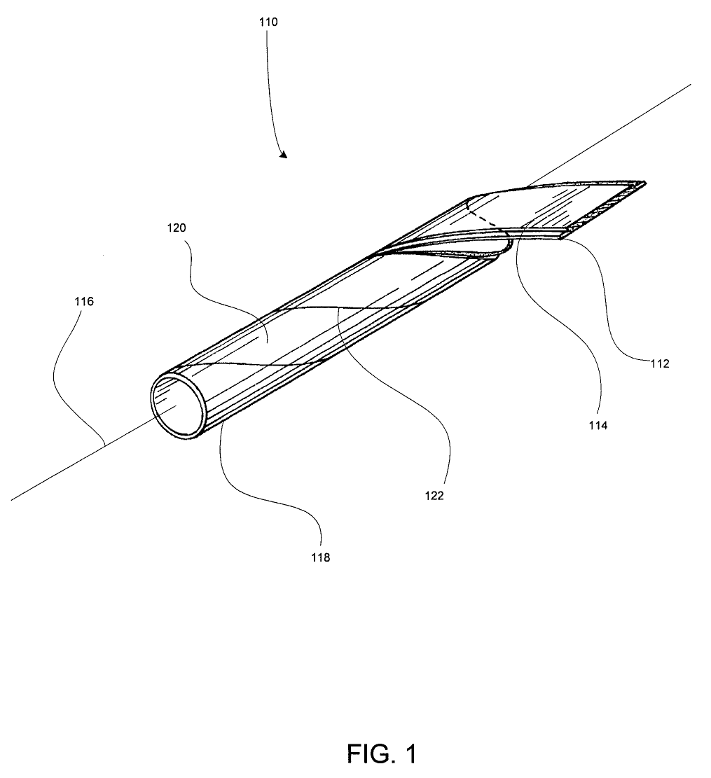

FIG. 1 illustrates an embodiment of a paperboard core 110 according to the present disclosure, the paperboard core 110 being illustrated in a partially deconstructed form. The paperboard core comprises one or more strips 112, 114 of paperboard wrapped about an axis 116 and secured together to form an elongate structure 118. The elongate structure 118 may comprise a tubular shape, as illustrated in FIG. 1. In alternate embodiments the elongate structure 118 may instead take the form of a conical shape, or other shapes depending on the specific application. The core 110 is illustrated as a spirally wound core in which the strips 112, 114 are helically wrapped, but cores in accordance with the invention can instead be convolutedly wrapped.

The outermost portion of the paperboard core 110 defines a winding surface 120 on which yarns may be wound. As described above, the paperboard core 110 may require additional features to ensure oil resistance and sufficient friction with the yarn. In this regard, Applicants made the unexpected discovery that a coating of a polymer material on the paperboard core 110 can provide superior oil resistance as compared to a film of the same type of material, as further described below. The material forming the coating, which may comprise one or more layers, is preferably a PVDC polymer. Alternatively, the coating may be made of a low density polyethylene (LDPE) polymer. The coating may be applied as a liquid onto the paperboard core 110 such as by roll-coating the polymer onto the winding surface 120, and then dried or otherwise cured to make the coating substantially uninterrupted along the winding surface. Multiple layers of the coating may be sequentially applied and cured individually. It may be unexpected that a coating could provide superior oil resistance as compared to a film, particularly because the porous surface of the strips 112, 114 of paperboard might be expected to hinder the formation of a uniform layer of the polymer material. One skilled in the art may instead expect that a film would act as a better barrier than a coating, because of the more-uniform nature of the film.

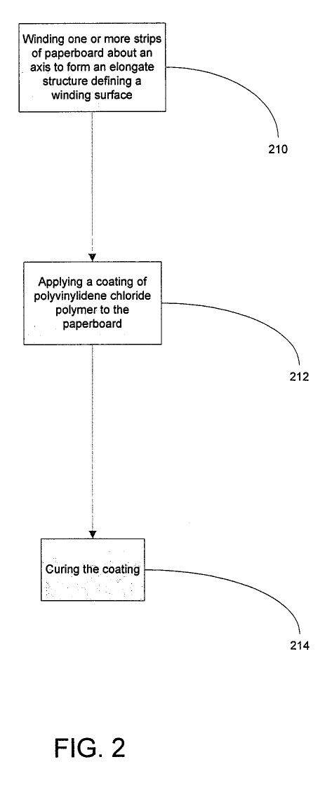

Embodiments of the present disclosure include methods of manufacturing a paperboard core 110 suitable for use in winding yarns, as described above and illustrated in FIG. 1. As illustrated in FIG. 2, the method may comprise a step 210 of winding one or more strips of paperboard about an axis to form an elongate structure defining a winding surface. The method further comprises the step 212 of applying a coating of PVDC or other polymer such as LDPE to the paperboard. The method further comprises the step 214 of curing the coating, such as by drying. According to this method, the step 212 of applying the coating may comprise coating the winding surface of the core after the paperboard is wound. Additionally, the step of coating the winding surface may further comprise creating a substantially uninterrupted coating along the winding surface. In this regard, a paperboard core with a coating may avoid overlapping joints or gaps associated with use of a film. The step of coating the winding surface may comprise roll-coating the polymer onto the winding surface. The step of roll-coating the polymer may comprise rotating the paperboard core against a rotating cylinder that is partially immersed in the polymer. However, the step 212 of applying a coating of the polymer may take a number of different forms. For example, additional embodiments may spray-coat the polymer onto the winding surface, or apply the polymer onto the winding surface using a wick, brush, or the like.

In additional embodiments, the step 212 of applying the coating may comprise coating the radially outer surface of at least one of the one or more strips prior to the step 210 of winding the one or more strips. The step 212 of applying the coating may comprise roll-coating the polymer onto the radially outer surface of the one or more strips. Other methods, such as spray-coating or wick-coating, as discussed above, may alternatively be used to coat the strips of the paperboard.

Additionally, the step of coating the radially outer surface may further comprise the step of coating the winding surface after the step 210 of winding the one or more strips. In this embodiment, the method combines both coating the strips prior to winding and coating the winding the surface after winding. The combination of these two steps may provide additional oil resistance.

Thus, in terms of the embodiment illustrated in FIG. 1, the polymer coating may be applied before, after, or both before and after the strips 112, 114 of paperboard are wound about the axis 116 to form the elongate structure 118. When the polymer coating is applied only before the strips 112, 114 of paperboard are wrapped about the axis 116 to form the elongate structure 118, the polymer coating may not resist oil as well as when the winding surface 120 is coated after the strips of paperboard are wound about the axis to form the elongate structure. This is because seams 122 between the one or more strips 112, 114 of paperboard may provide pathways through which oil may migrate.

Returning to FIG. 2, regardless of whether the coating is applied before or after winding the strips of paperboard, the step 212 of applying the coating may comprise applying a single layer of the polymer. In alternate embodiments, the step 212 of applying the coating may comprise applying a plurality of layers of the polymer. In this case, the step 214 of curing the coating may be repeated for each of the plurality of layers of the polymer, such that each layer is cured before the next layer is applied to it. The curing of each layer individually may allow the plurality of layers to combine to form a thicker coating, for example when the liquid polymer is relatively thin (i.e., of low viscosity) and cannot otherwise be thickened. As discussed below, the number of layers of the coating affects the oil resistance and frictional properties of the paperboard core.

Applicants conducted experimental tests on paperboard samples, which yielded the above-mentioned unexpected results. Tests were conducted using coated paperboard and film-covered paperboard samples. One film used in the tests was a SARAN™ film, which consists of a PVDC polymer. The coated paperboard comprised coatings of a PVDC polymer. Samples having from one to four layers of PVDC were tested. Additionally, the tests were conducted on uncoated paperboard, which served as a baseline.

One test conducted on the samples was a moisture vapor transmission rate (MVTR) test. MVTR is a measure of the amount of water vapor that passes through a sheet of material per unit time per unit area under specified steady conditions. Lower moisture vapor transmission rates are indicative of better oil resistance. MVTR was tested for the samples using a gravimetric determination method. In particular, the samples (having a specified area) were sealed across the top of a dish in which a desiccant (anhydrous calcium chloride), was placed in order to form the testing apparatus. The testing apparatuses were then placed in a chamber having controlled relative humidity and the change in weight of each of the apparatuses was recorded as a function of time.

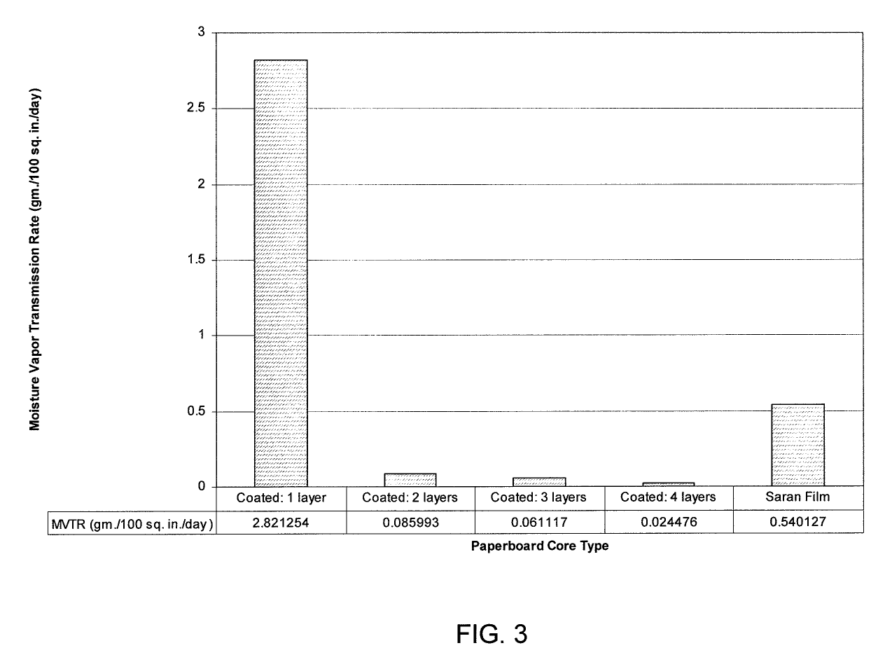

The MVTR testing showed that for the uncoated paperboard, the MVTR was very high, and hence this sample failed the MVTR test. This was expected because paperboard is known to have poor oil resistance qualities. The MVTR data for the remainder of the samples is displayed in FIG. 3, in terms of grams per 100 square inches per day. As illustrated, the sample comprising a single-layer coating resulted in a greater MVTR than the SARAN™ film sample. Specifically, the single layer coating sample was found to have an MVTR of 2.82 gm./100 in.²/day, whereas the SARAN™ film sample had an MVTR of 0.54 gm./100 in.²/day. However, coated samples comprising two to four layers of PVDC polymer provided lower moisture vapor transmission rates than that of the SARAN™ film sample. In particular, the coated samples with two to four layers of polymer yielded moisture vapor transmission rates between 0.09 gm./100 in.²/day and 0.02 gm./100 in.²/day. As lower moisture vapor transmission rates are indicative of better oil resistance, and because oil resistance is desirable in order to prevent yarn oils from penetrating and weakening the paperboard core, the coated samples comprising two to four layers were found to be superior to the SARAN™ film-covered sample in this test. In particular, coatings comprising two to four layers provided significantly better moisture transmission rates, less than a fifth that of the SARAN™ film-covered sample.

An additional test conducted on the samples assessed the porosity of each of the samples. Porosity is a measure of the void spaces in a material. Porosity was tested by determining the time that elapses for one hundred cubic centimeters of air to pass through each sample. The test was conducted using a Densometer #45405 manufactured by L. E. Gurley of Troy, N.Y.

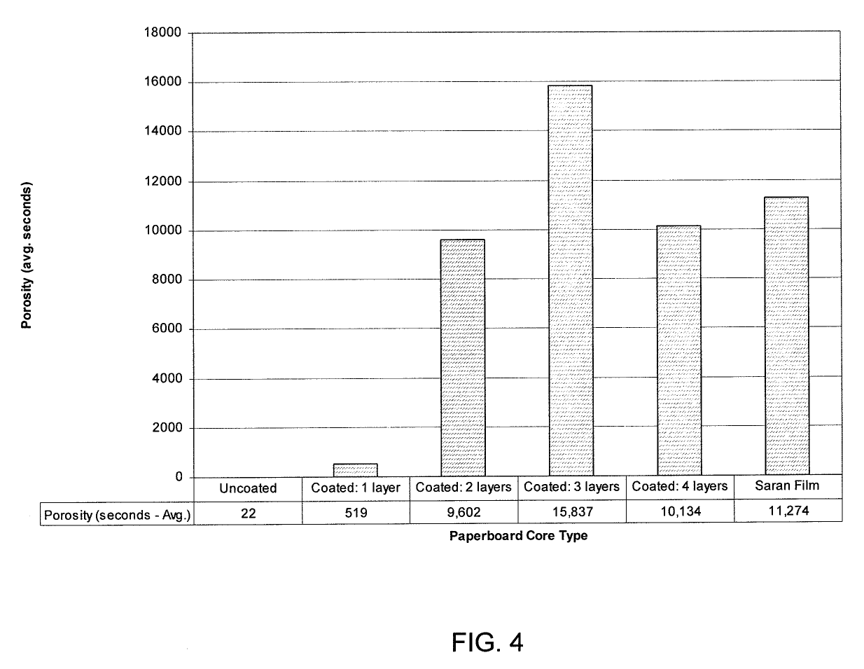

The porosity data for the samples is illustrated in FIG. 4. Porosity is displayed in seconds, with longer times corresponding to lower porosity, and hence longer times are indicative of better oil resistance. As illustrated, the test volume of air was able to travel through the uncoated paperboard core in only 22 seconds. The time was 519 seconds for the coated sample comprising one layer of PVDC. For the SARAN™ film-covered sample, the time was 11,274 seconds. The coated samples comprising two to four layers of PVDC achieved times between 9,602 seconds and 15,837 seconds, which are of similar magnitude to that provided by the SARAN™ film-covered sample. While there is some variability among the data for the coated samples, overall the data show that the coated samples comprising two to four layers of polymer are of similar porosity to that of the SARAN™ film-covered sample.

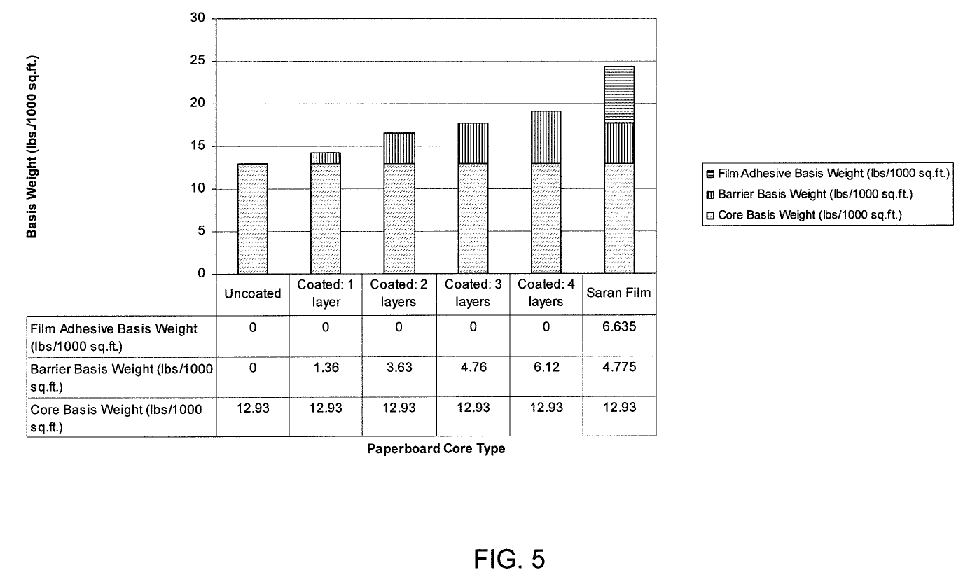

One concern with regard to the coated samples providing similar, if not better, oil resistance relative to the film-coated paperboard is the possibility that there could have been a greater quantity of PVDC on the coated paperboard. To determine if this was the case, basis weights for each of the above described samples were measured. As illustrated in FIG. 5, the uncoated paperboard had a basis weight of 12.93 lbs./1000 ft.². This same paperboard was used in each of the remaining samples. Thus, by subtracting the paperboard basis weight from the total basis weight, the basis weight of the coating(s) of polymer was determined for each of the coated samples. The total basis weight of the coatings ranged between 1.36 and 6.12 lbs./1000 ft.². In order to compare the coating weights to the SARAN™ film weight, it was necessary to subtract out the basis weight of the adhesive (6.64 lbs./1000 ft.²) used to adhere the SARAN™ film to the paperboard. This yielded a basis weight for the SARAN™ film of 4.78 lbs./1000 ft.². Comparing this number to the coating basis weights, each of the coatings having one to three layers uses less PVDC on a mass per unit area than the SARAN™ film basis, with the three layer coating at 4.76 lbs./1000 ft.² being nearly equal to that of the SARAN™ film. Accordingly, each of the coated samples comprising one to three layers of PVDC may be fairly compared to the SARAN™ film-covered sample without concern that the positive results are merely due to use of a greater mass of PVDC. Further, with regard to the coating comprising four layers, the four coatings have a greater basis weight than the SARAN™ film. However, when the weight of the adhesive is factored in, which is not required in the coated samples, less total material on a mass per unit area basis is applied to the paperboard for even the coated sample comprising four layers.

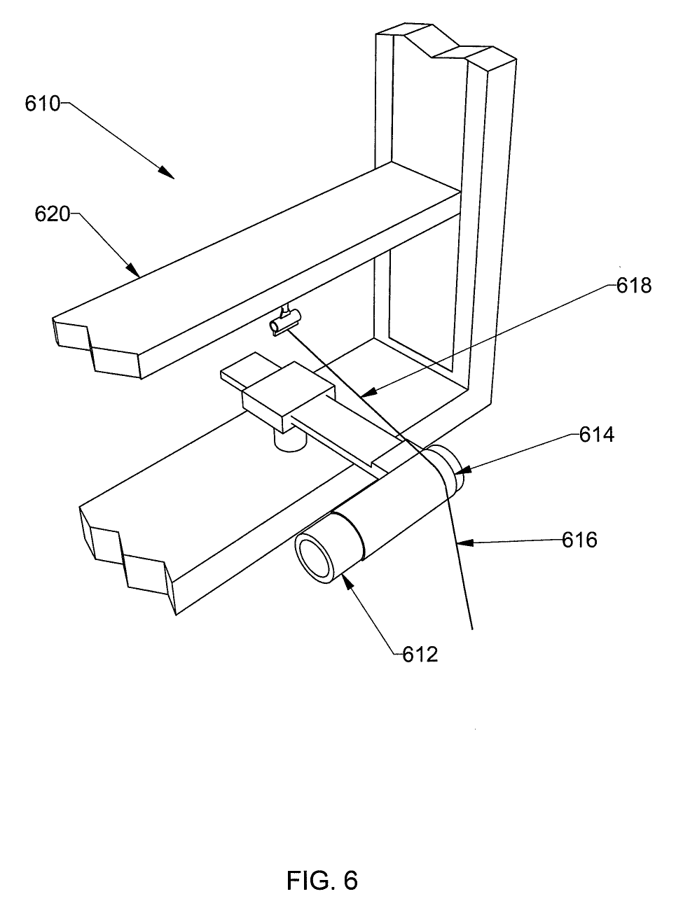

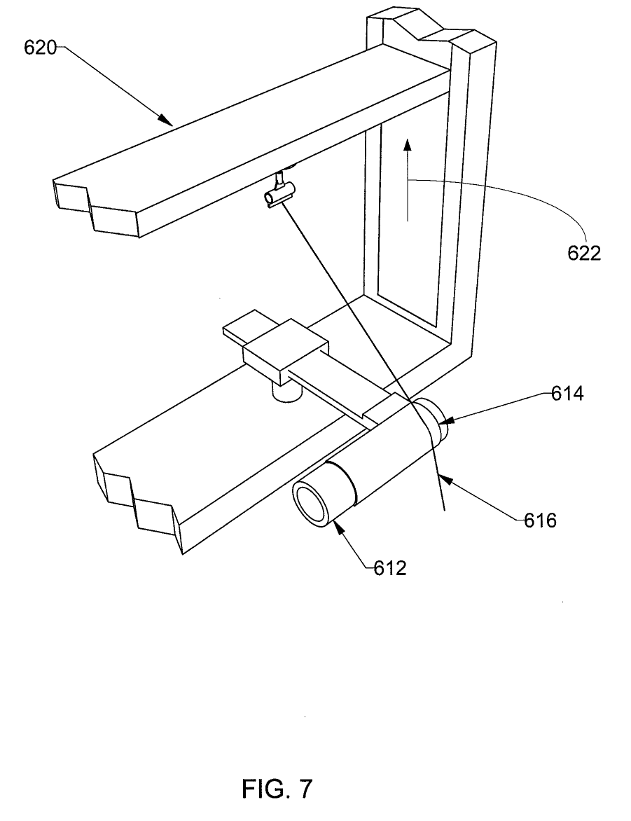

While the tests relating to oil resistance yielded favorable results even when factoring in the mass of material applied to the paperboard core, coated paperboard cores must also produce sufficient friction to be useable to wind yarns. Therefore, additional tests were conducted in order to assess the frictional characteristics of each of the samples. As illustrated in FIG. 6, Applicants developed a tension tester 610 for this purpose. The tension tester 610 comprises a jig 612 that is round to simulate the shape of a paperboard tube. A paperboard sample 614 is secured on the round jig 612 and a length of spandex yarn 616 is wrapped partially around the sample on the jig. The upper end 618 of the spandex yarn 616 is attached to a moveable head 620. As illustrated in FIG. 7, the moveable head 620 is translated in a vertical direction 622 so as to pull the spandex yarn 616 across the sample 614 on the jig 612. The force required to pull the spandex yarn 616 over the sample 614 was recorded for each of the samples.

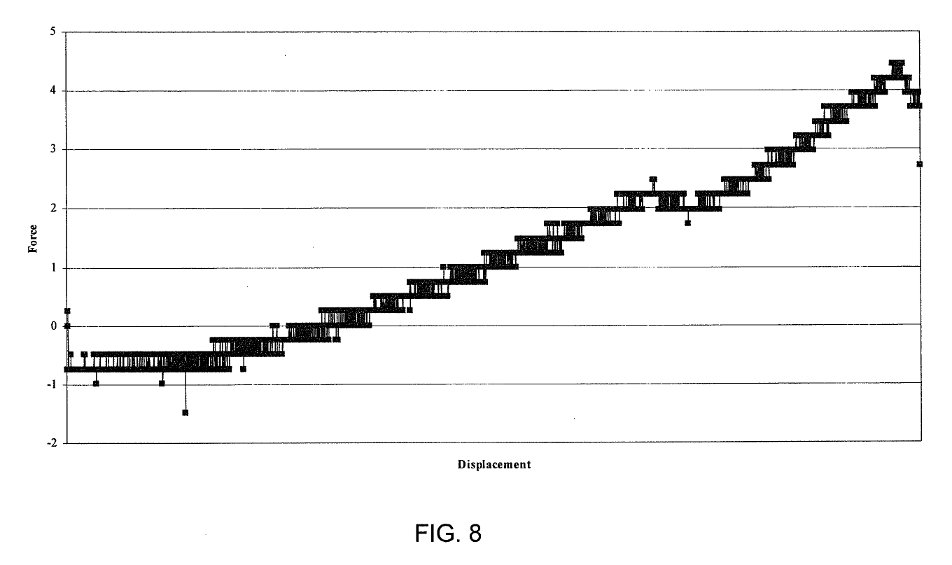

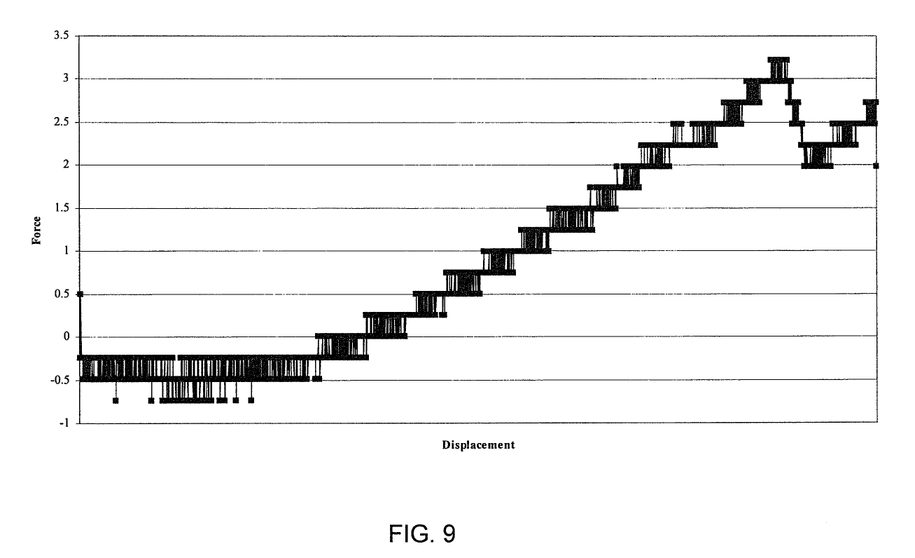

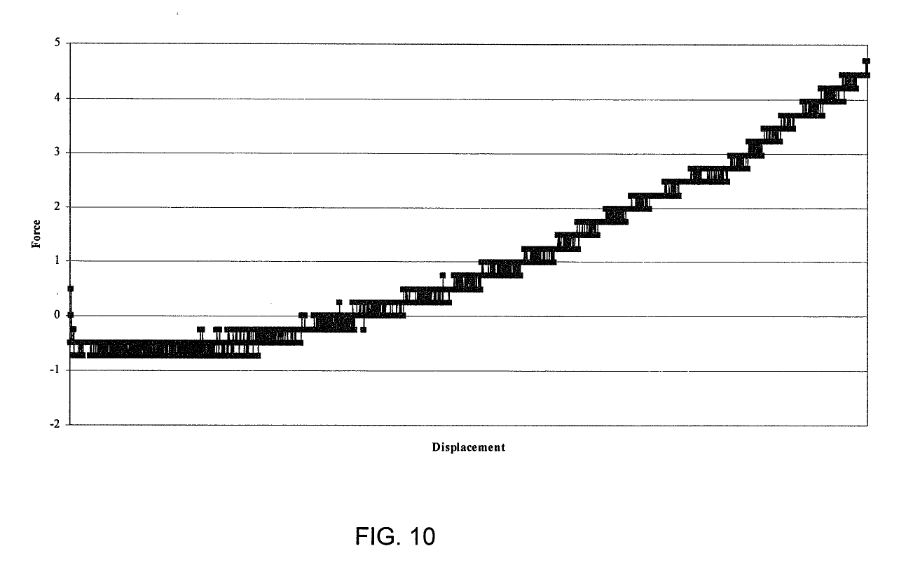

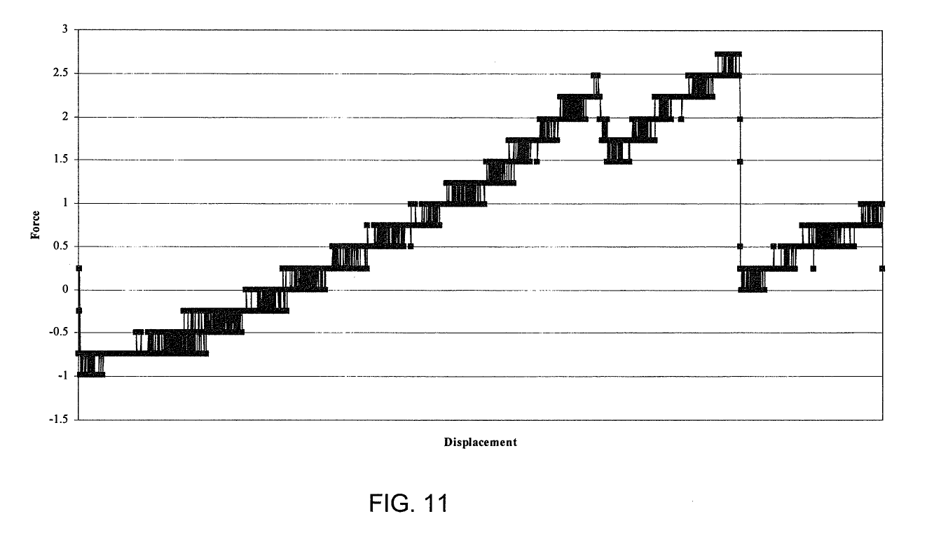

For the friction tests a cellophane film-covered sample was tested in addition to the above-described SARAN™ film-covered sample and the coated samples. Test results for the cellophane film-covered sample are shown in FIGS. 8 and 9. Results for the SARAN™ film-covered sample are shown in FIGS. 10 and 11. As seen in FIGS. 8-11, the force required to pull the spandex yarn across the samples increases with the displacement of the moveable head in an upward sloping manner. In some of the tests, such as those illustrated in FIGS. 9 and 11, the curve includes “steps,” which correspond to slippage of the spandex yarn on the tested sample. In terms of the magnitude of the force created by the displacement, the maximum force required to pull the spandex across the samples was in the range of 2.5-5 grams-force for each of the film-covered samples.

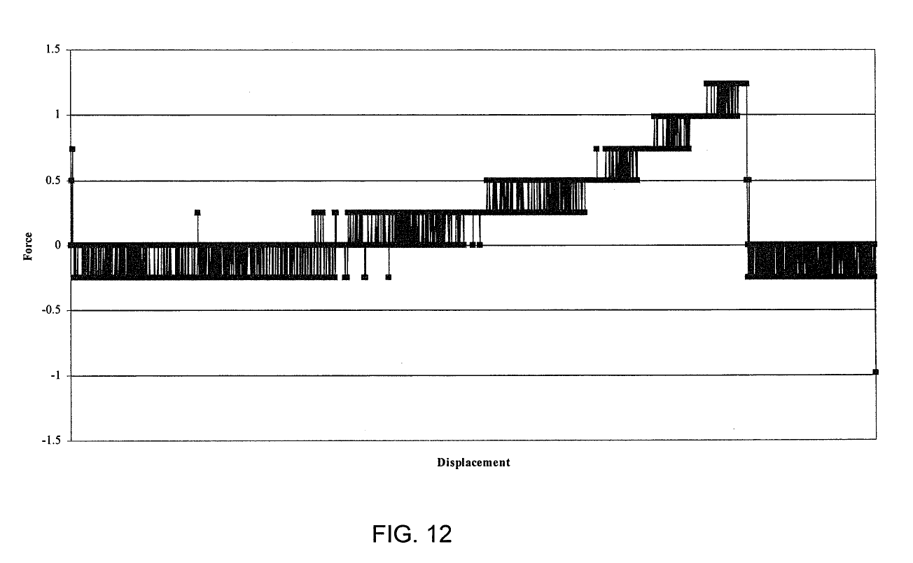

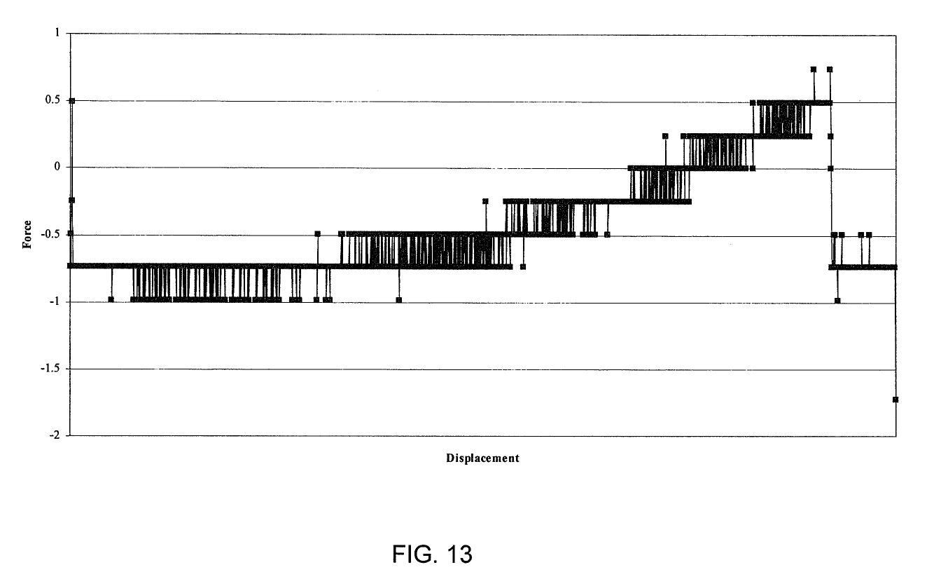

With regard to the coated samples, FIGS. 12-15 illustrate the results of the friction tests. The results of testing a coated sample comprising a single layer of PVDC are illustrated in FIG. 12 and the test results for a coating comprising two layers are illustrated in FIG. 13. As shown, the friction behavior of these coated samples creates an upward sloping curve similar to that created by the film-covered samples, except the magnitude of the force is less, with the maximum recorded force for these two samples being less than 1.5 grams-force. It is unclear why the coating comprising two layers of polymer, as illustrated in FIG. 13, resulted in less maximum force than the coating comprising one layer of polymer, as illustrated in FIG. 12.

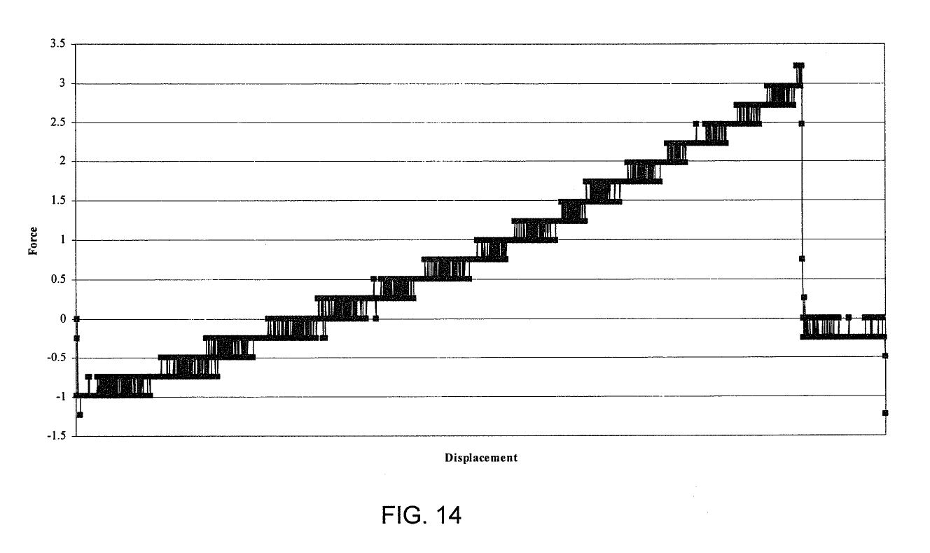

However, as illustrated in FIG. 14, the coated sample comprising three layers of the polymer yielded a maximum recorded force exceeding 3 grams-force, which is within the range of the maximum recorded forces from the film-covered samples. The three layer coated sample also produced a generally upward sloping curve. Accordingly, the three layer coated sample demonstrated frictional characteristics similar to that of the film-covered samples.

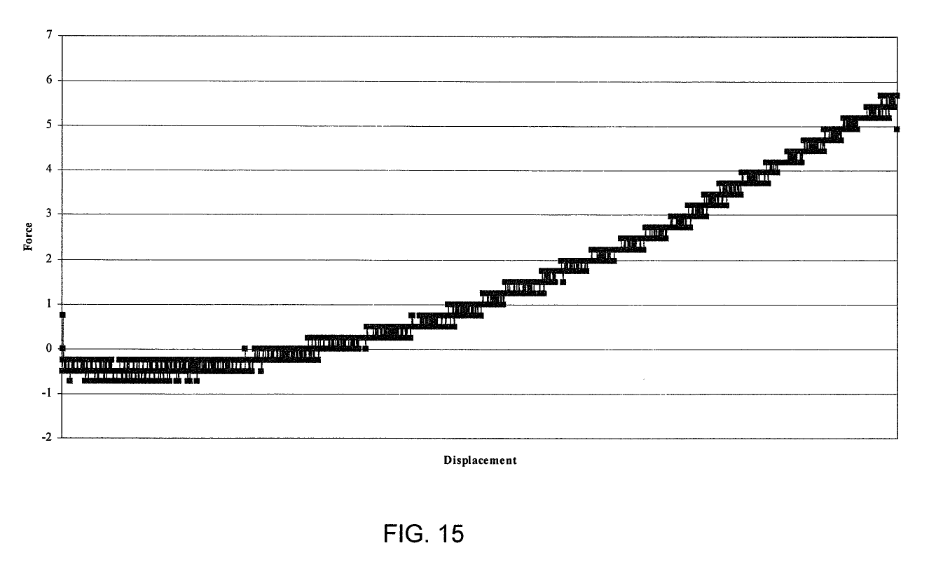

Finally, the coated sample comprising four layers was tested. As illustrated in FIG. 15, this sample additionally produced a generally upward sloping frictional curve. However, the maximum force produced as the spandex yarn was dragged across the four layer coated sample was over 5 grams-force, which exceeds the maximum recorded force produced by the film-covered samples. Accordingly, depending on the number of layers of coating applied, coated paperboard cores may produce frictional force equaling or exceeding the frictional force produced by film-covered paperboard cores.

Thus, it is possible to achieve the desired frictional and moisture barrier properties of the paperboard core at least in part by selecting the number of layers of the polymer which are applied. The frictional and moisture barrier properties corresponding to each number of layers of polymer may be determined empirically as described above, or by other methods. Other variables, such as the thickness of each layer, may also affect the moisture barrier and frictional properties, and hence may also be adjusted in order to obtain the desired properties of the paperboard core.

As described above, coated paperboard cores may create the necessary friction required for yarn transfers, and may also unexpectedly provide better moisture barrier properties as compared to a film depending on the number of layers of polymer comprising the coating. However, coated paperboard cores may have additional benefits in that use of a coating instead of a film may allow the core to be recycled using conventional processes without first removing the PVDC polymer. In contrast, in order to recycle film-covered paperboard cores, it may be necessary to either remove the film prior to recycling or use costly sorting and filtering equipment in the recycling process. Accordingly, coated paperboard cores may provide viable substitutes for film-covered paperboard cores while providing additional benefits not produced by film-covered paperboard cores.

Many modifications and other embodiments will come to mind to one skilled in the art to which these embodiments pertain having the benefit of the teachings presented in the foregoing descriptions and the associated drawings. Therefore, it is to be understood that modifications and other embodiments are intended to be included within the scope of the appended claims. Although specific terms are employed herein, they are used in a generic and descriptive sense only and not for purposes of limitation.

That which is claimed:

1. A paperboard core suitable for use in winding yarns, comprising:
one or more strips of paperboard wrapped about an axis and secured together to form an elongate structure, the elongate structure defining a winding surface; and
a coating of a polyvinylidene chloride polymer covering the winding surface,
wherein the coating is applied to the winding surface as a liquid and then cured.

2. The paperboard core of claim 1, wherein the coating is substantially uninterrupted along the winding surface.

3. The paperboard core of claim 1, wherein the coating is applied to the winding surface by roll-coating.

4. The paperboard core of claim 1, wherein the coating comprises a plurality of layers.

5. The paperboard core of claim 4, wherein each of the plurality of layers is cured individually.

6. The paperboard core of claim 1, wherein the paperboard core is repulpable without first removing the polyvinylidene chloride polymer.

8. The paperboard core of claim 1, wherein the elongate structure comprises a tubular shape.

9. The paperboard core of claim 1, wherein the elongate structure comprises a conical shape.

10. A method of manufacturing a paperboard core suitable for use in winding yarns, comprising the steps of:
winding one or more strips of paperboard about an axis to form an elongate structure defining a winding surface, the one or more strips each comprising a radially outer surface;
applying a coating of a polyvinylidene chloride polymer to the paperboard; and
curing the coating.

11. The method of claim 10, wherein the step of applying the coating comprises coating the winding surface.

12. The method of claim 11, wherein the step of applying the coating further comprises creating a substantially uninterrupted coating along the winding surface.

13. The method of claim 11, wherein the step of applying the coating further comprises roll-coating the polymer onto the winding surface.

14. The method of claim 10, wherein the step of applying the coating comprises coating the radially outer surface of at least one of the one or more strips prior to the step of winding the one or more strips.

15. The method of claim 14, wherein the step of applying the coating further comprises roll-coating the polymer onto the radially outer surface.

16. The method of claim 14, wherein the step of applying the coating further comprises coating the winding surface after the step of winding the one or more strips.

17. The method of claim 10, wherein the step of applying the coating comprises applying a single layer of the polymer.

18. The method of claim 10, wherein the step of applying the coating comprises applying a plurality of layers of the polymer.

19. The method of claim 18, wherein the step of curing the coating is repeated for each of the plurality of layers of the polymer.

20. The method of claim 10, further comprising achieving a desired frictional characteristic, wherein the frictional characteristic is determined at least in part by the number of layers of the polymer which are applied.

21. The method of claim 10, further comprising achieving a desired moisture barrier characteristic, wherein the moisture barrier characteristic is determined at least in part by the number of layers of the polymer which are applied.
